(19) United States
(12) Patent Application Publication
(10) Pub. No.: US 2006/0180718 A1
(43) Pub. Date: Aug. 17, 2006

(54) Conduit retention clip

(75) Inventor: Vernon A. Harrison JR., Conroe, TX (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: Capro, Inc.

(21) Appl. No.: 11/057,351

(22) Filed: Feb. 14, 2005

(51) Int. Cl. F16L 3/08

(52) U.S. Cl. 248/74.2

(57) ABSTRACT

A conduit retention clip has an upper and a lower portion. The upper portion has a C-shaped portion. Entrance into the C-shaped portion is obtained by passing a cylindrical object through two inwardly facing flexible fingers. The lower portion includes a connection for attachment of the conduit retention clip to a panel.

### FIELD OF INVENTION

This invention pertains to a clip device; more particularly, the present invention pertains to a clip used with a cylindrical object, such as the outer conduit portion of a cable and conduit assembly. The clip may be used to affix the cable and conduit assembly to another object, such as a panel.

### BACKGROUND

While clips of various sizes have been available for many years, it has been found that currently available clips for attaching cylindrical objects, such as the outer conduit portion of a cable and conduit assembly, can slide past tape markers, other locating markers, or objects typically found on cable and conduit assemblies. Tape markers and other locating markers may be used for identification, positioning, or for a variety of other functions associated with assembly procedures. Other objects found on cable and conduit assemblies may include foam, heat score marks, or crimped objects.

Because many prior art clips have openings therein, the clips may work themselves past tape markers, other markers, or other objects, thereby mispositioning the clips. Accordingly, a need remains in the art for a conduit retention clip which will not slide past a tape marker, other markers, or other objects typically found on cable and conduit assemblies.

### SUMMARY

The conduit retention clip of the present invention is constructed and arranged for mounting on the outer conduit portion of a cable and conduit assembly and includes flexible fingers which prevent it from sliding past a tape marker, other markers, or other objects typically found on a cable and conduit assembly.

The conduit retention clip of the present invention has an upper portion and a lower portion. On the upper portion are flexible fingers for receipt of a cylindrical object, such as the outer conduit portion of a cable and conduit assembly. The flexible fingers allow the conduit retention clip to be put on a conduit, a tube, a rod, or other type of cylindrical object. Once the conduit, the tube, the rod, the other type of cylindrical object passes through the flexible fingers, the flexibility of the fingers allows them to snap back in place to create a barrier which prevents the clip from sliding past items typically attached to the outer portion of a cable and conduit assembly, such as tape markers, foam, a heat score, or a crimped object.

On the lower portion of the conduit retention clip is a panel retention portion to facilitate the mounting of the conduit retention clip to a stationary object such as a panel or plate.

The unique feature of the conduit retention clip of the present invention is the flexible fingers that prevent the clip from sliding past items attached to a cylindrical object, but at the same time allowing a range of motion and full rotation of the retention clip around the cylindrical object.

### DESCRIPTION OF THE DRAWING FIGURES

A better understanding of the conduit retention clip of the present invention may be had by reference to the drawing figures, wherein:

FIG. 1 is a perspective view of a first embodiment of the conduit retention clip;

FIG. 2 is a side elevational view of the first embodiment of the conduit retention clip surrounding a conduit and cable assembly;

FIG. 3 is a front elevational view in partial section at 3-3 in FIG. 2 of the first embodiment of the conduit retention clip attached to a conduit and cable assembly;

FIG. 4 is a perspective view of a second embodiment of the conduit retention clip;

FIG. 5 is a side elevational view of the second embodiment of the conduit retention clip surrounding a conduit and cable assembly;

FIG. 6 is a front elevational view in partial section at 6-6 in FIG. 5 of the second embodiment of conduit retention clip attached to a conduit and cable assembly; and

FIG. 7 is a perspective view showing a conduit and cable assembly including a tape marker to illustrate the operation of the conduit retention clip of the present invention.

### DESCRIPTION OF THE EMBODIMENTS

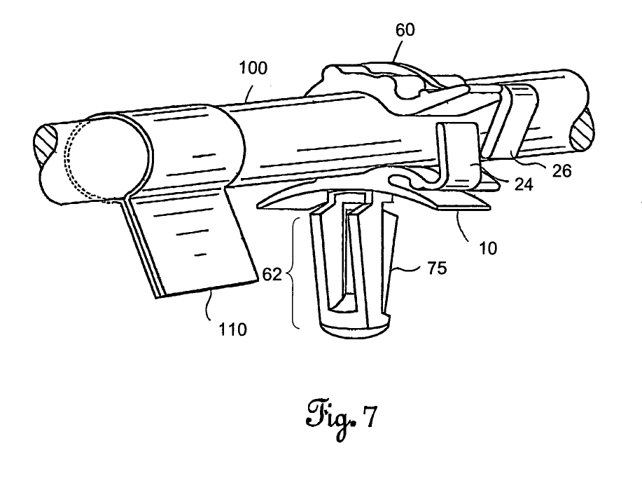

As shown in FIG. 7, the disclosed conduit retention clip 10 of the present invention is designed to snap over a conduit and cable assembly 100 and to be positioned on the conduit and cable assembly 100 near an object located on the cable and conduit assembly 100. This object may be a tape marker 110 formed from tape doubled over the conduit and cable assembly to form flagged ends. Proper positioning of the conduit retention clip 10 on the conduit and cable assembly 100 allows it to be easily mountable to a stationary portion of a vehicle or a piece of outdoor power equipment. Typically, the lower portion 62 of the conduit retention clip is inserted into a mounting hole which positions the conduit retention clip and holds the cable and conduit assembly 100 in a desired location.

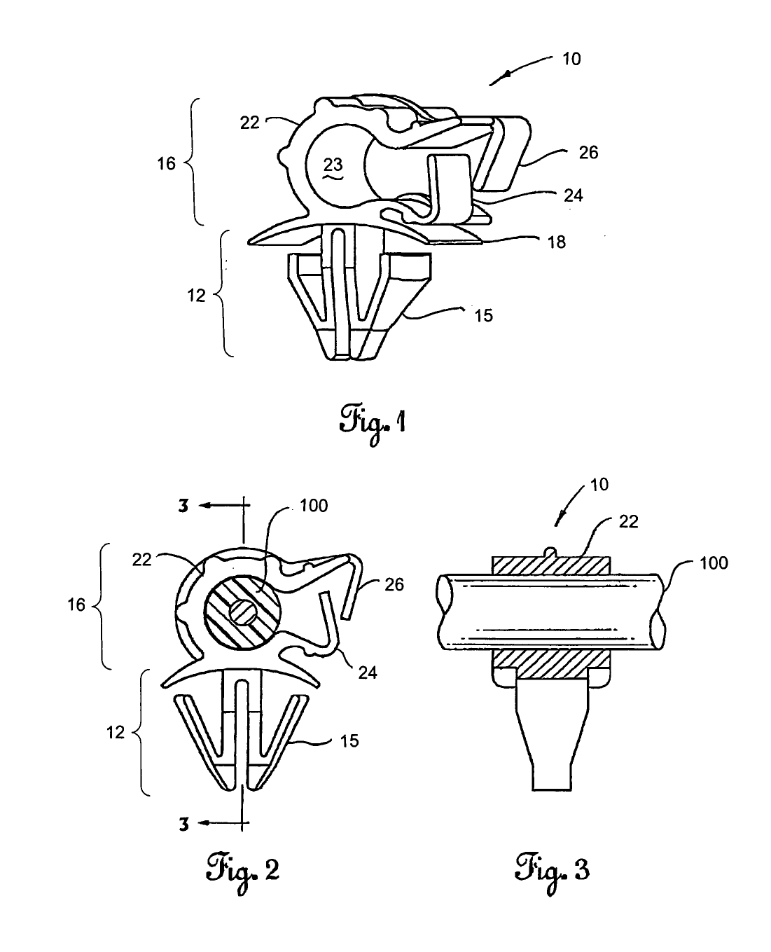

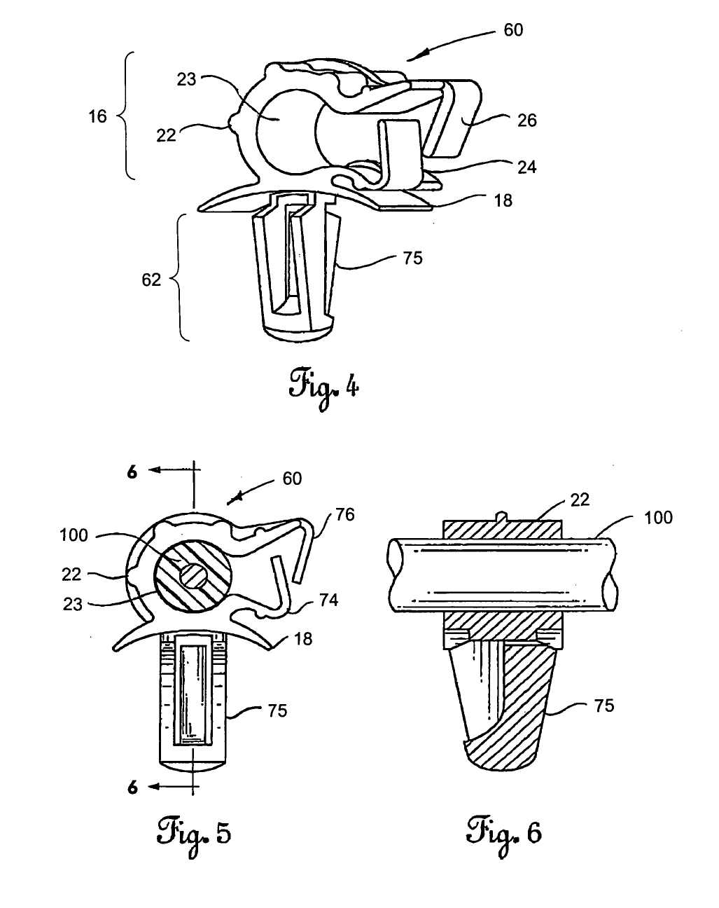

Shown in FIGS. 1, 2, and 3 is a first embodiment of a conduit retention clip assembly 10. The lower portion 12 is sized to pass through an opening in a panel or plate (not shown). As best shown in FIG. 1 and FIG. 2, spring fingers 15 are used to retain the conduit retention clip 10 in place, once it has been pushed through a hole in the panel. Alternatively, a compressible conical section 75 may be used as shown in FIGS. 4, 5, and 6. Those of ordinary skill in the art will understand that still other methods of attachment may be used, such as a snap ring and groove formed on the bottom 12 of the conduit retention clip 10.

Positioned over the lower portion 12 is an upper holder portion 16. The upper holder portion 16 may include a flat or curved bottom 18, depending on the shape of the stationary object to which the conduit retention clip 10 is affixed. A curved bottom 18 may be used to provide a tension force between the conduit retention clip 10 and the panel to prevent or reduce movement—which movement may produce an unacceptable rattle. The upper holder portion 16 includes a C-shaped portion 22 sized to fit around a cylindrical object, such as a cable and conduit assembly 100 (FIG. 3). Entry into the C-shaped portion 22 is accomplished by passing the cylindrical object through two or more inwardly facing flexible fingers 24 and 26.

Shown in FIGS. 4, 5, and 6 is a second embodiment of the conduit retention clip assembly 60. Like the first embodiment of the conduit retention clip shown in FIGS. 1, 2, and 3, the lower portion 62 is one of a variety of different configurations for securing the clip assembly 60 to a panel or plate. Specifically, a collapsible cone 75 is used instead of the spring fingers 15 shown in FIGS. 1, 2, and 3. The upper portion 16 of the second embodiment of the conduit retention clip 60 also includes a substantially C-shaped portion 22 sized to fit around a range of substantially cylindrical objects 100. Extending outwardly from the opening in the C-shaped portion are two inwardly facing flexible fingers 24 and 26. It is the overlap of these fingers which prevents the clip 10 from sliding past tape markers, foam, a heat score, or a crimped object.

When it is desired to place the cylindrical object 100 within the C-shaped portion 22, the cylindrical object 100 is simply placed against the outer surface of the inwardly facing flexible fingers 24 and 26. A small amount of pressure will cause the cylindrical object to pass into and contact the inside 23 of the C-shaped portion 22. The flexible nature of the C-shaped portion 22 will allow the conduit retention clip 10 to be pushed onto the cylindrical object or conduit 100 and still be securely retained on the cylindrical object or conduit 100. In the preferred embodiment, the conduit retention clip 10 is still loose enough to permit rotation about the cylindrical object or conduit 100 and axial travel along the cylindrical object or conduit 100 within space defined by the features on the conduit, such as tape markers. The retention portion 75 of the lower portion 62 may then be pushed through a hole in a panel up to the undersurface of bottom 18. It is the flexible feature of the disclosed conduit retention clip 10 that retains the conduit retention clip 10 of the present invention on cylindrical objects better than prior art clips. Yet, this flexibility allows the disclosed conduit retention clip 10 to rotate and move within its designated location while at the same time being more difficult to slide out of position—specifically from moving past the tape flags or other items positioned on a conduit.

While the present invention system and method have been disclosed according to the preferred embodiment of the invention, those of ordinary skill in the art will understand that other embodiments have also been enabled. Such other embodiments shall fall within the scope and meaning of the appended claims.

I claim:

1. A clip for retention of a cylindrical object to a stationary object, said clip comprising:
a lower portion, said lower portion including means for affixing the clip to the stationary object;
a substantially C-shaped upper portion including a flexible portion for contacting and surrounding the cylindrical object, said substantially C-shaped portion further including flexible fingers extending therefrom, said flexible fingers further including inward-facing flexible keepers which prevent the clip from sliding past a marker on the cylindrical object.

2. The clip as defined in claim 1 wherein the contact between said substantially C-shaped upper portion and the cylindrical object will permit both rotation of the clip around the cylindrical object and axial movement along the cylindrical object.

3. A process for retaining a cylindrical object to a stationary object, said process comprising the steps of:
inserting the cylindrical object through a pair of inward-facing flexible fingers into a C-shaped portion in the upper portion of a conduit retention clip;
moving the cylindrical object into contact with the interior of said C-shaped portion in the upper portion of the conduit retention clip;
affixing said conduit retention clip to the stationary object.
